(19) United States
(12) Patent Application Publication
(10) Pub. No.: US 2012/0038533 A1
(43) Pub. Date: Feb. 16, 2012

(54) BROADBAND ANTENNA AND RADIATION DEVICE INCLUDED IN THE SAME

(75) Inventors: Min-Seok Jung, Bucheon (KR); Chul-Keun Park, Bucheon (KR)

(73) Assignee: ACE TECHNOLOGIES CORPORATION, Incheon (KR)

(21) Appl. No.: 13/214,687

(22) Filed: Aug. 22, 2011

Related U.S. Application Data
(63) Continuation of application No. PCT/KR2010/001041, filed on Feb. 19, 2010.

(30) Foreign Application Priority Data
Feb. 23, 2009 (KR) 10-2009-0014798

(51) Int. Cl. H01Q 9/16; H01Q 21/00

(52) U.S. Cl. 343/810; 343/793; 343/818

(57) ABSTRACT

An antenna for realizing broadband and/or multi-band using branch members is disclosed. The antenna includes a reflection plate and a radiation device disposed on the reflection plate. Here, the radiation device includes a first feeding point and a first dipole member electrically connected to the first feeding point. At least one first branch member is formed to one side of the first dipole member, and one or more second branch member is formed to another side of the first dipole member.

### CROSS-REFERENCE TO RELATED APPLICATION

This is a continuation application of PCT/KR2010/001041 filed on Feb. 19, 2010, which claims the benefit of Korean Application No. 10-2009-014798 filed Feb. 23, 2009, the entire contents of which applications are incorporated herein by reference.

### TECHNICAL FIELD

Example embodiments of the present invention relate to antennas for realizing broadband and/or multi-band using multi current paths and radiation devices included in the same.

### BACKGROUND ART

An antenna transmits/receives electromagnetic wave using at least one radiation device. Here, the radiation device as a radiator has generally a structure shown in following FIG. 1.

FIG. 1 is a view illustrating structure of common radiation device in an antenna.

In FIG. 1, a radiation device 100 includes dipole elements 110, 112, 114 and 116 and a feeding section 118.

The feeding section 118 includes feeing points 120A, 120B, 120C and 120D and a connection line 122.

The first feeding point 120A is connected to the fourth dipole element 116, and the second feeding point 120B is connected to the third dipole element 114.

The third feeding point 120C is connected to the second dipole element 112, and the fourth feeding point 120D is connected to the first dipole element 110.

In the radiation device 100, in case that current is inputted into the fourth feeding point 120D, a part of the current flows to the first dipole element 110 and the other current is provided to the third dipole element 114 through the connection line 122 formed on an upper surface of the feeding section 118 and the second feeding point 120B. Accordingly, electric field is generated from each of the first dipole element 110 and the third dipole element 114, and +45° polarized wave is generated by the electric field. In this case, the second dipole element 112 and the fourth dipole element 116 do not affect to generation of generation of +45° polarized wave.

In case that current is inputted into the first feeding point 120A, a part of the current flows to the fourth dipole element 116 and the other current is provided to the second dipole element 112 through a connection line formed on a back side of the feeding section 118 and the third feeding point 120C. Accordingly, electric field is generated from each of the second dipole element 112 and the fourth dipole element 116, and −45° polarized wave is generated by the electric field. In this case, the first dipole element 110 and the third dipole element 114 do not affect to the generation of −45° polarized wave.

That is, the radiation device 100 generates ±45° polarized wave at single frequency band.

Recently, it has been required that a device, e.g. a mobile phone realizes two or more frequency bands. However, the antenna having the radiation device 100 realizes only one frequency band.

In other words, the antenna may not realize multi band and broadband, and thus can't satisfy the requirement.

### SUMMARY OF THE DISCLOSURE

An example embodiment of the present invention provides an antenna for realizing broadband and/or multi-band using branch members and a radiation device included in the same.

In one aspect, the present invention provides a radiation device in a broadband antenna comprising: a first feeding point; and a first dipole member electrically connected to the first feeding point. Here, at least one first branch member is formed to one side of the first dipole member, and one or more second branch member is formed to another side of the first dipole member.

The first branch members and the second branch members are symmetrically disposed.

Length of the first branch member reduces according as distance of the first branch member and the first feeding point increases.

At least one of the first branch members is not parallel to the other first branch members.

At least one of the first branch members has different width from the other first branch members.

The radiation device further includes a second feeding point; and a second dipole member electrically connected to the second feeding point. Here, a third branch member facing to the first branch member is formed to one side of the second dipole member, and electromagnetic coupling generates between the third branch member and the first branch member.

The first branch member is disposed in parallel to the third branch member.

Space between the first branch member and the third branch member reduces according as distance between the first branch member or the third branch member and corresponding feeding point increases.

Space between the first branch member and the third branch member increases according as distance between the first branch member or the third branch member and corresponding feeding point augments.

At least one of the first branch members and the second branch members is separable from the first dipole member.

In another aspect, the present invention provides a radiation device in a broadband antenna comprising: a first feeding point and a second feeding point; a first dipole member electrically connected to the first feeding point; and a second dipole member electrically connected to the second feeding point. Here, at least one first branch member is formed to a side of the first dipole member, one or more second branch member facing to the first branch member is formed to a side of the second dipole member, and electromagnetic coupling generates between the first branch member and the second branch member.

In still another aspect, the present invention provides a broadband antenna comprising: a reflection plate; and a radiation device disposed on the reflection plate. The radiation device includes: a first feeding point; and a first dipole member electrically connected to the first feeding point. Here, at least one first branch member is formed to one side of the first dipole member, and one or more second branch member is formed to another side of the first dipole member.

The first branch members are symmetrically disposed to the second branch members, and length of the first branch member reduces according as distance between the first branch member and the first feeding point increases.

The antenna of claim further includes a second feeding point; and a second dipole member electrically connected to the second feeding point. Here, at least one third branch member facing to the first branch member is formed to a side of the second dipole member, and electromagnetic coupling generates between the third branch member and the first branch member.

A radiation device in an antenna of the present invention has branch members for providing multi current paths, and so the antenna may realize multi band and broadband. For example, the antenna may realize at least two bands of K-PCS band (1.7 GHz to 1.8 GHz), WCDMA band (1.9 GHz to 2.2 GHz), WiBro band (2.3 GHz to 2.327 GHz, 2.331 GHz to 2.358 GHz, 2.363 GHz to 2.390 GHz) and WiMAX band (2.5 GHz to 3.5 GHz).

Since the frequency band of the antenna is changed by adjusting number, angle and space, etc. of the branch members formed in the radiation device, the antenna may realize easily various frequency bands using one radiation device. Especially, in case that the branch members are separable from corresponding dipole member, the antenna may realize more easily desired frequency band.

### BRIEF DESCRIPTION OF DRAWINGS

Example embodiments of the present invention will become more apparent by describing in detail example embodiments of the present invention with reference to the accompanying drawings, in which:

FIG. 1 is a view illustrating structure of common radiation device in an antenna;

FIG. 2 is a perspective view illustrating a radiation device according to a first example embodiment of the present invention;

FIG. 3 is a view illustrating current distribution of the radiation device in FIG. 2 according to one example embodiment of the present invention;

FIG. 4 to FIG. 7 are views illustrating return loss, isolation and radiation pattern of the radiation device in FIG. 2;

FIG. 8 is a view illustrating radiation devices having various branch members according to one example embodiment of the present invention;

FIG. 9 is a view illustrating return loss characteristics of the radiation devices in FIG. 8;

FIG. 10 is a view illustrating isolation characteristics of the radiation devices in FIG. 8;

FIG. 11 is a view illustrating radiation devices having various number of branch members according to one example embodiment of the present invention;

FIG. 12 is a view illustrating return loss characteristics of the radiation devices in FIG. 11;

FIG. 13 is a view illustrating isolation characteristics of the radiation devices in FIG. 11; and

FIG. 14 is a view illustrating an antenna having a radiation device according to one example embodiment of the present invention.

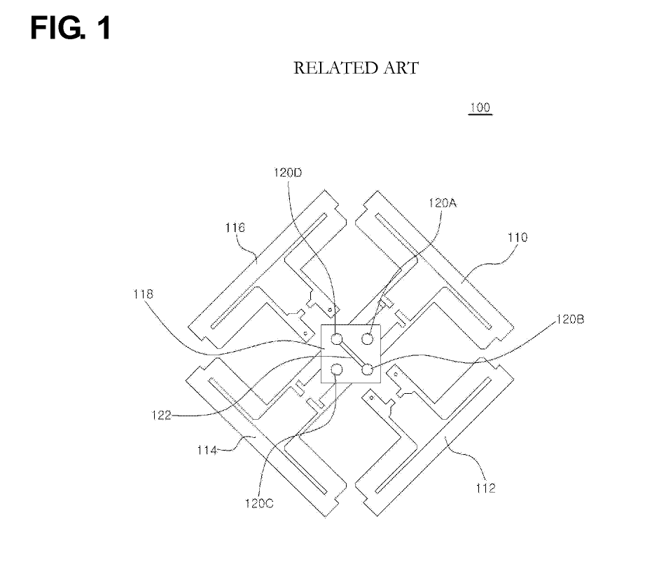

### DETAILED DESCRIPTION OF THE DISCLOSURE

Hereinafter, embodiments of the present invention will be described in detail with reference to accompanying drawings.

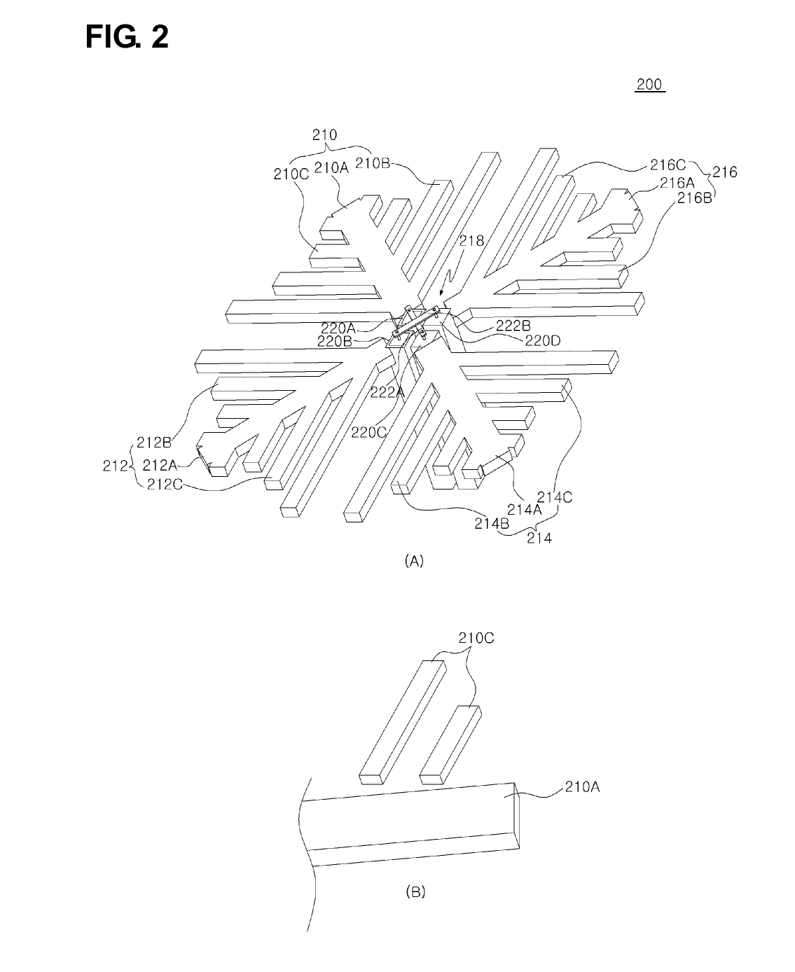

FIG. 2 is a perspective view illustrating a radiation device according to a first example embodiment of the present invention.

In FIG. 2(A), a radiation device 200 in an antenna of the present invention outputs a radiation pattern, and includes dipole elements, e.g. four dipole elements 210, 212, 214 and 216 and a feeding section 218.

Generally, the antenna outputs radiation pattern using a plurality of radiation devices. Here, the radiation device 200 is one of the radiation devices. It is preferable that the radiation devices have structure shown in FIG. 2.

A first dipole element 210 includes a dipole member 210A, at least one branch members 210B formed on one side of the dipole member 210A and at least one branch members 210C formed on other side of the dipole member 210A.

The dipole member 210A is a body of the first dipole element 210, and is electrically connected to a first feeding point 220A. As a result, current flows to the dipole member 210A through the first feeding point 220A.

The branch members 210B and 210C are formed on sides of the dipole member 210A to realize broadband, and may be formed in one body with the dipole member 210A. Here, the number of the branch members 210B and 210C is not limited, and may be variously changed in accordance with an user's object.

In case that the dipole member 210A has a structure shown in FIG. 2, the current provided to the dipole member 210A flows to the branch members 210B and 210C, i.e. multi current paths are formed.

In one embodiment of the present invention, the branch members 210B and the branch members 210C are formed symmetrically as shown in FIG. 2, and length of each of the branch members 210B and 210C may reduce according as distance of the branch member 210B or 210C and the feeding section 218 increases. Here, the branch member 210B or 210C having small length affects mainly to realize high frequency band, and the branch member 210B or 210C having great length affects mainly to realize low frequency band.

In FIG. 2, the branch members 210B and 210C have the same width. However, at least one of the branch members 210B and 210C may have different width from the other members 210B and 210C. In addition, length of the branch members 210B and 210C may not reduce according as distance of the branch member 210B or 210C and the feeding section 218 increases, but may be disposed irregularly. That is, the branch members 210B and 210C may be variously modified as long as they form multi current paths.

The second dipole element 212 includes a dipole member 212A, at least one branch members 212B formed on one side of the dipole member 212A and at least one branch members 212C formed on other side of the dipole member 212A. The second dipole element 212 is electrically connected to a second feeding point 220B.

The third dipole element 214 includes a dipole member 214A, at least one branch members 214B formed on one side of the dipole member 214A and at least one branch members 214C formed on other side of the dipole member 214A. The third dipole element 214 is electrically connected to a third feeding point 220C.

The fourth dipole element 216 includes a dipole member 216A, at least one branch members 216B formed on one side of the dipole member 216A and at least one branch members 216C formed on other side of the dipole member 216A. The fourth dipole element 216 is electrically connected to a fourth feeding point 220D.

Hereinafter, disposition of the dipole elements 210, 212, 214 and 216 will be described.

In one embodiment of the present invention, the dipole members 210A, 212A, 214A and 216A of the dipole elements 210, 212, 214 and 216 may be vertically disposed in sequence. Furthermore, outermost member of the branch members 210B of for example the first dipole element 210 may be disposed in parallel to outermost member of the branch members 210C of the fourth dipole element 216. However, the outermost member of the branch members 210B of the first dipole element 210 may not be disposed in parallel to outermost member of the branch members 210C of the fourth dipole element 216. In other words, space between the branch members 210B and 216C may narrow or increase according as distance between the branch member 210B or 216C and the feeding section 218 augments. Capacitance between the branch member 210B and the branch member 216C is changed in accordance with space between the branch member 210B and the branch member 216C, and so the frequency band of the antenna may be varied depending on the space. Accordingly, the user may set properly the space and disposition of the branch members 210B and 216C in accordance with frequency band desired by the user.

Now referring to FIG. 2(A), the feeding section 218 includes the feeding points 220A, 220B, 220C and 220D and connection lines 222A and 222B.

The first feeding point 220A is connected to the first dipole element 210, and first current supplied from outside is provided to the first dipole element 210 through the first feeding point 220A.

Additionally, the first feeding point 220A is connected to the third feeding point 220C through the first connection line 222A, and thus the first current supplied to the first feeding point 220A is provided to the third feeding point 220C through the first connection line 222A.

In case that the first current is provided to the first dipole element 210 and the third dipole element 214, electric field is generated from the first dipole element 210 and the third dipole element 214, respectively. As a result, −45° polarized wave is generated by the electric fields.

The second feeding point 220B is connected to the second dipole element 212, and second current supplied from outside is provided to the second dipole element 212 through the second feeding point 220B.

Moreover, the second feeding point 220B is connected to the fourth feeding point 220D through the second connection line 222B, and thus the second current supplied to the second feeding point 220B is provided to the fourth feeding point 220D through the second connection line 222B.

In case that the second current is provided to the second dipole element 212 and the fourth dipole element 216, electric field is generated from the second dipole element 212 and the fourth dipole element 216, respectively. As a result, +45° polarized wave is generated by the electric fields.

In brief, in the radiation device 200 of the present invention, the branch members 210B, 210C, 212B, 212C, 214B, 214C, 216B and 216C are formed to the dipole members 210A, 212A, 214A and 216A to realize broadband and/or multi band. For example, the radiation device 200 may realize at least two bands of K-PCS band (1.7 GHz to 1.8 GHz), WCDMA band (1.9 GHz to 2.2 GHz), WiBro band (2.3 GHz to 2.327 GHz, 2.331 GHz to 2.358 GHz, 2.363 GHz to 2.390 GHz) and WiMAX band (2.5 GHz to 3.5 GHz). This will be described in detail with reference to accompanying drawings.

In above description, the dipole member and corresponding branch members are formed in one body. However, the branch member, e.g. 210C may be separable from the dipole member 210A as shown in FIG. 2(B), and be combined with the dipole member 210A when it is needed.

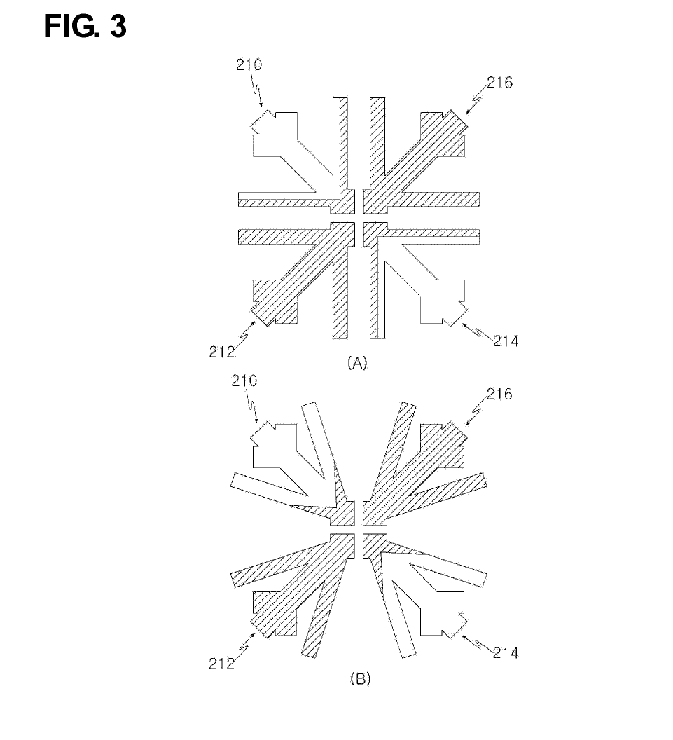

FIG. 3 is a view illustrating current distribution of the radiation device in FIG. 2 according to one example embodiment of the present invention. FIG. 3 shows the current distribution of the radiation device 200 having smaller number of the branch members compared with those in FIG. 2.

In FIG. 3, the radiation device 200 of the present embodiment includes four dipole elements 210, 212, 214 and 216. In case that current is provided to the second dipole element 212 and the fourth dipole element 216 to generate +45° polarized wave, electromagnetic coupling generates between the dipole element 210 and 214 and the dipole element 212 and 216 by the current provided to the second dipole element 212 and the fourth dipole element 216 as shown in FIG. 3(A) and FIG. 3(B). As a result, the first dipole element 210 and the third dipole element 214 affect to generation of 45° polarized wave.

On the other hand, the branch members in the radiation device 200 may have various structures, e.g. have structures shown in FIG. 3(A) and FIG. 3(B). Accordingly, coupling amount between the dipole elements is different in accordance with the structure.

In case that the branch members of the dipole elements 210, 212, 214 and 216 are adjacently disposed in parallel as shown in FIG. 3(A), capacitance for resonance frequency in following Equation 1 increases.

$$Resonance frequency ( f ) = \frac{1}{2 π \sqrt{LC}} \qquad [ Equation 1 ]$$

Whereas, in case that space between the branch members of the dipole elements 210, 212, 214 and 216 increases according as distance between the branch member and the feeding section 218 augments as shown in FIG. 3(B), capacitance reduces. As a result, the resonance frequency of the radiation device 200 in FIG. 3(B) is higher than that of the radiation device 200 in FIG. 3(A).

In short, the radiation device 200 of the present embodiment includes the branch members unlike conventional radiation device. Accordingly, unlike the conventional radiation device in which the dipole elements to which current is not provided do not affect to the other dipole elements to which current is provided, the dipole elements to which current is not provided affect to the dipole elements to which the current is provided in the radiation device 200 of the present embodiment. As a result, the radiation device 200 may realize broadband and/or multi band.

The structure of the radiation device 200 of the present embodiment may be variously modified as mentioned above. Here, the branch members affect to inductive characteristic, i.e. inductance, and the space between the branch members of the other dipole elements affects to conductive characteristic, i.e. capacitance. Accordingly, the user may set length, width and space, etc. of the branch members depending on the frequency band desired by the user.

In case that the branch member is separable from corresponding dipole member, the user may combine only specific branch members with the dipole member or combine the branch members having different length and width with the dipole member in accordance with the desired frequency band. As a result, it is convenient to make the radiation device.

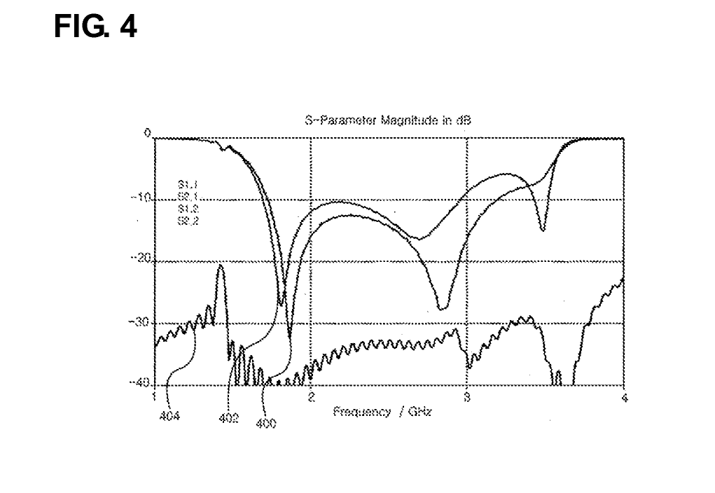

FIG. 4 to FIG. 7 are views illustrating return loss, isolation and radiation pattern of the radiation device in FIG. 2. Here, width of the dipole member 210A, 212A, 214A and 216A is set as 3.6 mm, length of each of the branch members having the greatest length is set as 18.954 mm, and width of each of the branch members is set as 2 mm. In addition, length of the branch members having the second length is set as 9.954 mm, length of the branch members having the third length is set as 3.954 mm, and length of the branch members having the smallest length is set as 0.954 mm.

FIG. 4 shows return loss measured from the radiation device 200.

Referring to a return loss curve 400 of the radiation device 200 for generating +45° polarized wave, it is verified that two resonance frequencies of about 1.87 GHz and approximately 2.85 GHz are realized.

Referring to a return loss curve 402 of the radiation device 200 for generating −45° polarized wave, it is verified that two resonance frequencies of about 1.8 GHz and approximately 2.7 GHz are realized.

Especially, it is measured that the frequency band of 1.46 GHz (1.73 GHz to 2.19 GHz) and 1.26 GHz (1.69 GHz to 2.95 GHz) satisfies return loss less than −10 dB. That is, it is verified through the experimental result that the radiation device 200 of the present invention has excellent broadband characteristic.

Referring to an isolation curve 404, isolation of the radiation device 200 has value less than −30 dB in desired frequency band as shown in FIG. 4. In other words, it is verified that the isolation between the dipole members 210, 212, 214 and 216 is excellent.

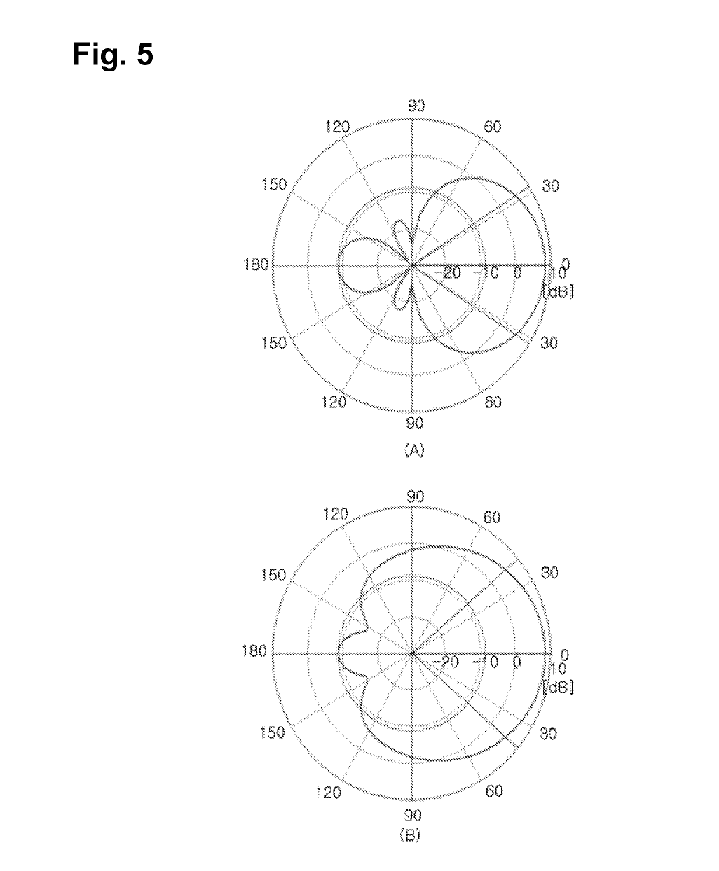

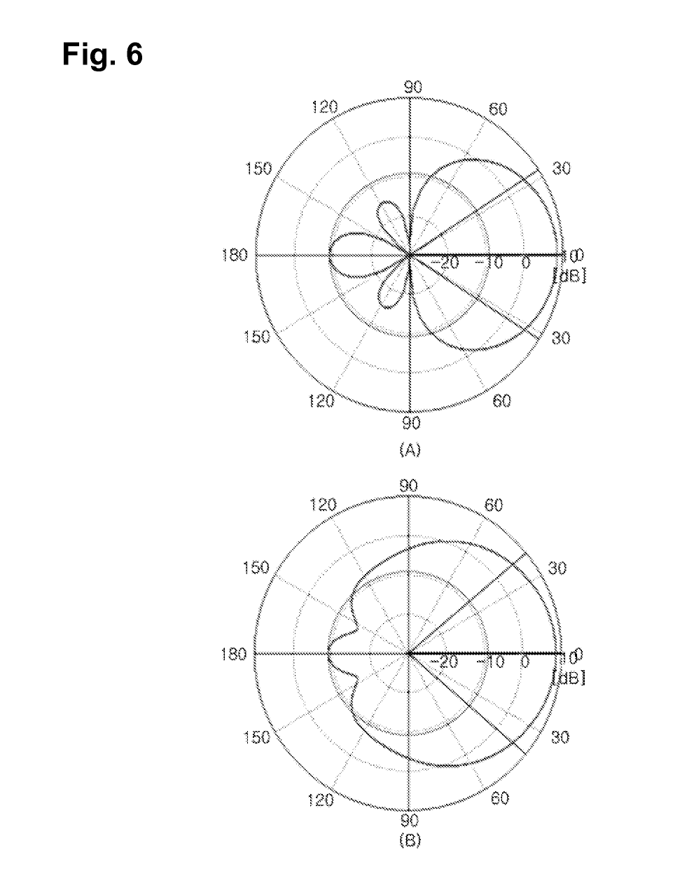

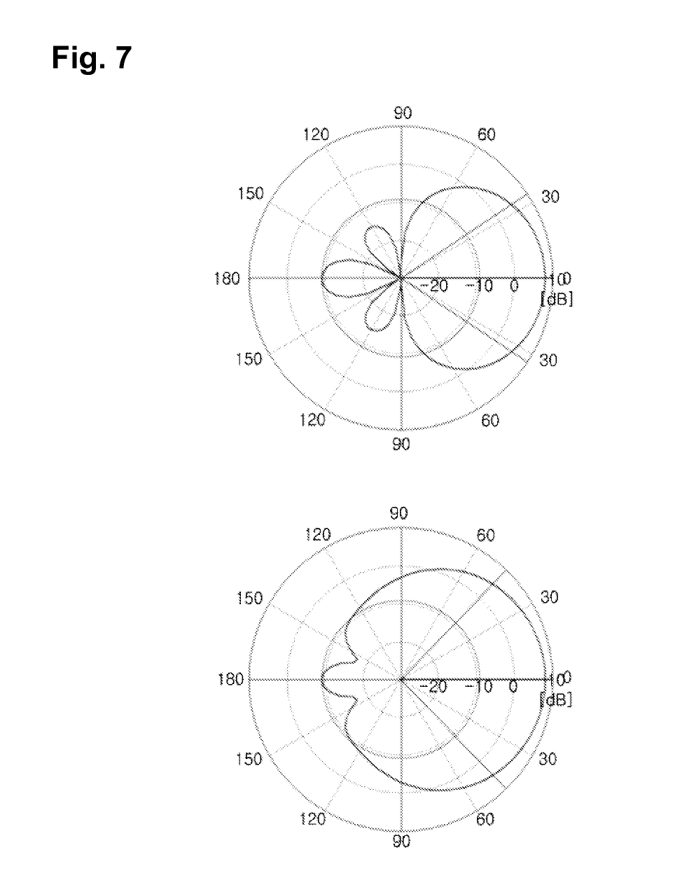

FIG. 5(A) shows +45° vertically polarized wave at 1.88 GHz, and FIG. 5(B) illustrates +45° horizontally polarized wave at 1.88 GHz. FIG. 6(A) shows +45° vertically polarized wave at 2.17 GHz, and FIG. 6(B) illustrates +45° horizontally polarized wave at 2.17 GHz. FIG. 7(A) shows +45° vertically polarized wave at 2.5 GHz, and FIG. 7(B) illustrates +45° horizontally polarized wave at 2.5 GHz.

As shown in FIG. 5 to FIG. 7, +45° polarized waves at frequencies of 1.88 GHz, 2.17 GHz and 2.5 GHz have similar shapes. That is, it is verified that radiation pattern desired by the user is outputted.

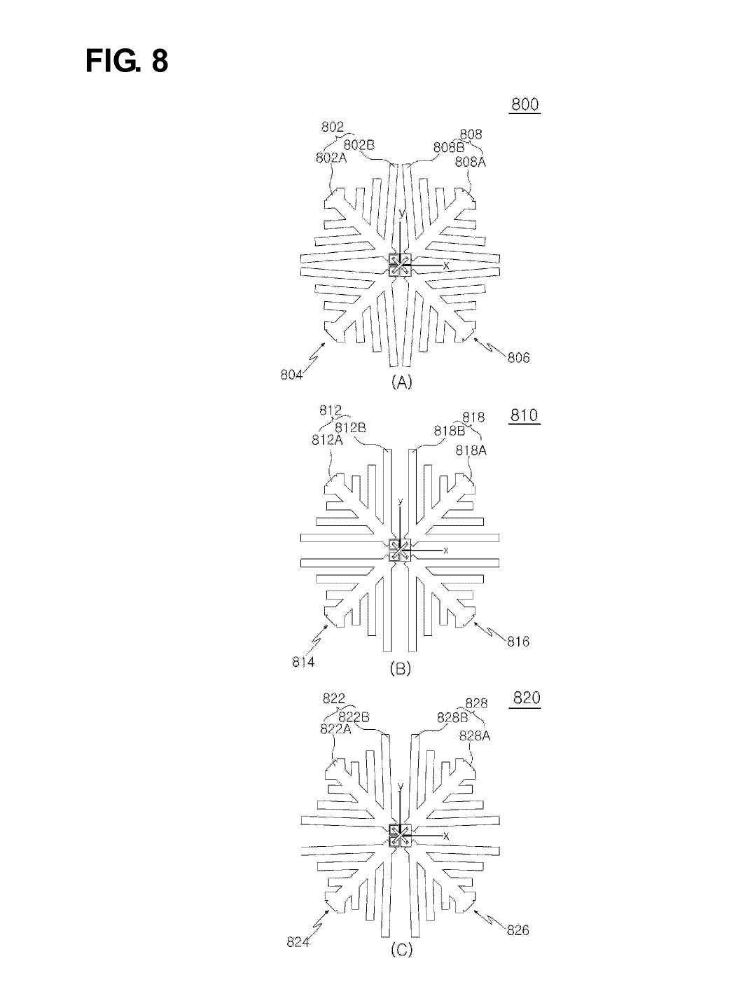

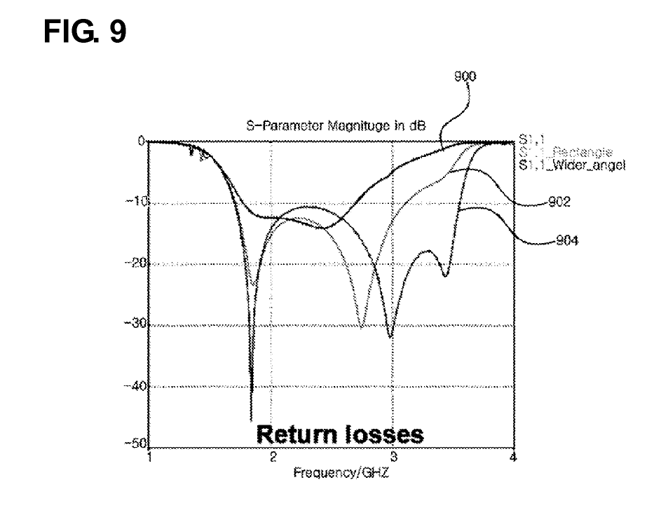

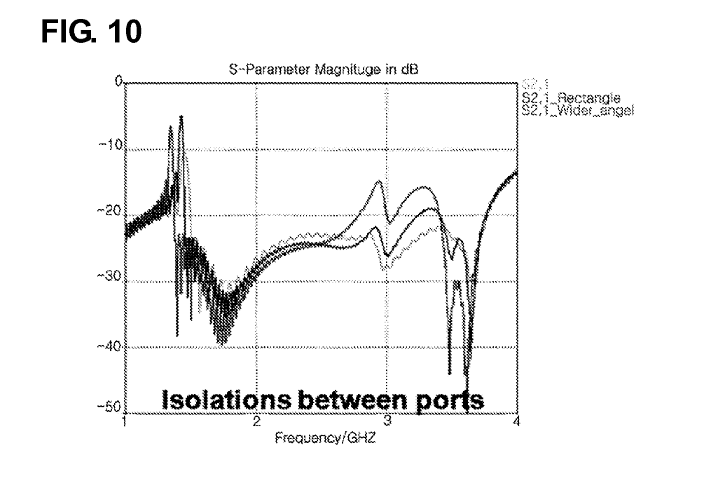

FIG. 8 is a view illustrating radiation devices having various branch members according to one example embodiment of the present invention, and FIG. 9 is a view illustrating return loss characteristics of the radiation devices in FIG. 8. FIG. 10 is a view illustrating isolation characteristics of the radiation devices in FIG. 8.

In FIG. 8(A), a radiation device 800 includes a first dipole element 802, a second dipole element 804, a third dipole element 806 and a fourth dipole element 808.

Space between branch members, e.g. space between a branch member 802B formed to a first dipole member 802A and a branch member 808B formed to a fourth dipole member 808A reduces according as distance of the branch member 802B and 808B and a feeding section increases. As a result, resonance frequency and capacitance of impedance increase according as the distance of the branch member 802B and 808B and a feeding section augments.

In FIG. 8(B), a radiation device 810 includes a first dipole element 812, a second dipole element 814, a third dipole element 816 and a fourth dipole element 818.

Space between branch members, e.g. space between a branch member 812B formed to a first dipole member 812A and a branch member 818B formed to a fourth dipole member 818A are constant. In other words, the branch member 812B is disposed in parallel to the branch member 818B. As a result, resonance frequency and capacitance of impedance are smaller than those of the radiation device 800.

In FIG. 8(C), a radiation device 820 includes a first dipole element 822, a second dipole element 824, a third dipole element 826 and a fourth dipole element 828.

Space between branch members, e.g. space between a branch member 822B formed to a first dipole member 822A and a branch member 828B formed to a fourth dipole member 828A increases according as distance of the branch member 822B and 828B and a feeding section augments. As a result, resonance frequency and capacitance of impedance are smaller than those of the radiation devices 800 and 810.

Hereinafter, return loss characteristics of the radiation devices 800, 810 and 820 will be described.

In FIG. 9, it is verified that frequency band in a return loss curve 902 for the radiation device 810 is wider than that in a return loss curve 900 for the radiation device 800 on the basis of −10 dB.

Additionally, it is verified that frequency band in a return loss curve 904 for the radiation device 820 is wider than that in the return loss curve 902 for the radiation device 810 on the basis of −10 dB. That is, the radiation device 820 in which the space between the branch members increases according as the distance between the branch member and a feeding section augments realizes the widest frequency band. This is because capacitance reduces according as the space between the branch members increases. This broadband is realized because impedance is matched by combining optimally inductance corresponding to length of the branch members and capacitance corresponding to the space between the branch members.

Since the capacitance of the radiation device 820 is smallest, resonance frequency of the radiation device 820 is higher than that of the radiation devices 800 and 810.

In FIG. 10, the radiation devices 800, 810 and 820 has isolation of below −30 dB in wide frequency band, i.e. the radiation devices 800, 810 and 820 have excellent isolation characteristics.

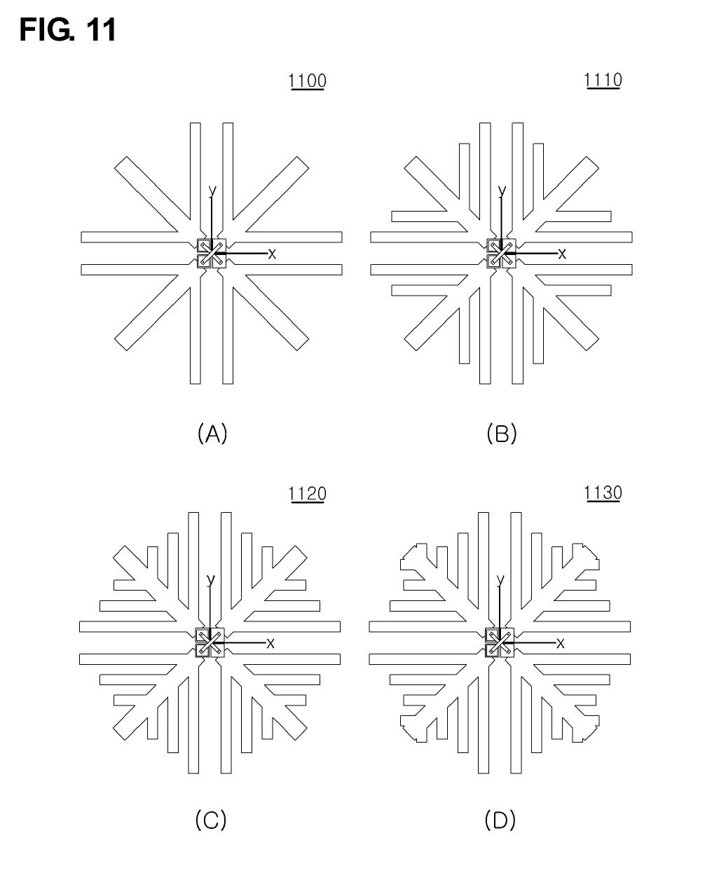

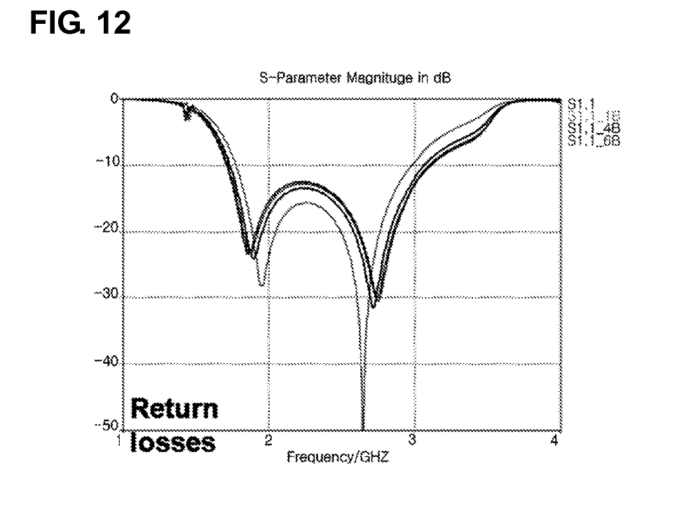

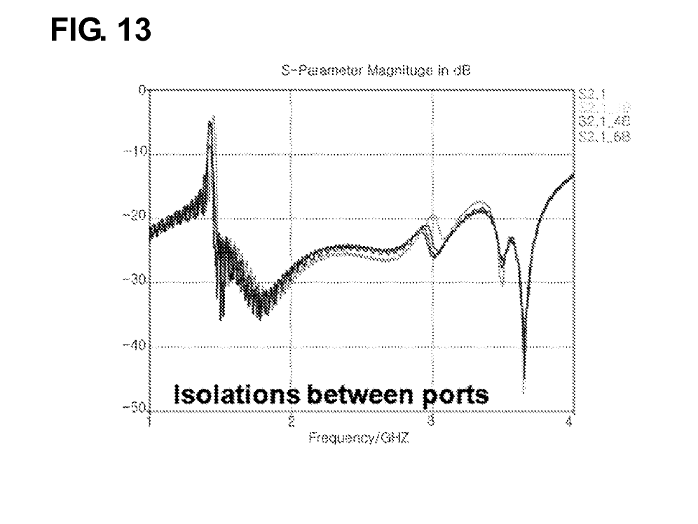

FIG. 11 is a view illustrating radiation devices having various number of branch members according to one example embodiment of the present invention, and FIG. 12 is a view illustrating return loss characteristics of the radiation devices in FIG. 11. FIG. 13 is a view illustrating isolation characteristics of the radiation devices in FIG. 11.

In FIG. 11, a branch member of one dipole element in radiation devices 1100, 1110, 1120 and 1130 is parallel to that of the other dipole element. Here, number of the branch members in the radiation devices 1100, 1110, 1120 and 1130 is different. In other words, the radiation devices 1100, 1110, 1120 and 1130 have the same structure, but the number of their branch members is different.

Hereinafter, return loss characteristics and isolation characteristics of the radiation devices 1100, 1110, 1120 and 1130 will be described.

As shown in FIG. 12, resonance frequencies of the radiation devices 1100, 1110, 1120 and 1130 are similar though number of the branch members of the radiation devices 1100, 1110, 1120 and 1130 is different. This is because the radiation devices 1100, 1110, 1120 and 1130 have the same structure. The radiation devices 1100, 1110, 1120 and 1130 realize two resonance frequencies.

In FIG. 13, the radiation devices 1100, 1110, 1120 and 1130 have isolation of below −30 dB in wide frequency band, i.e. the radiation devices 1100, 1110, 1120 and 1130 have excellent isolation characteristics.

In brief, it is verified that the space between the branch member of one dipole element and the branch member of another dipole element affects mainly to the broadband characteristic of the radiation device.

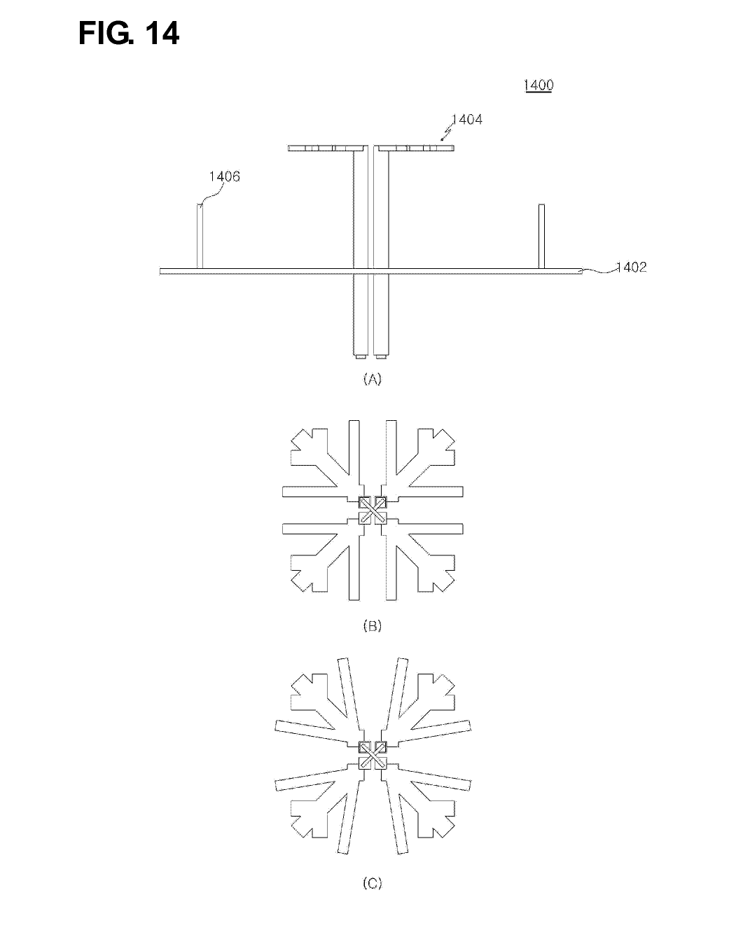

FIG. 14 is a view illustrating an antenna having a radiation device according to one example embodiment of the present invention.

In FIG. 14(A), an antenna 1400 of the present embodiment includes a reflection plate 1402, at least one radiation device 1404 disposed on the reflection plate 1402, and at least one choke member 1406 disposed on the reflection plate 1402.

Various radiation devices 1404, e.g. two radiation devices shown in FIG. 14(B) and FIG. 14(C) may be disposed in the antenna 1400 having the choke member 1406. The radiation device 1404 shown in FIG. 14(C) realizes wider frequency band than that shown in FIG. 14(B). In addition, isolation of the radiation device 1404 in FIG. 14(C) may be better than that of the radiation device 1404 in FIG. 14(B).

Hereinafter, beam width characteristic and cross-polarization characteristic will be described.

The radiation device 1404 in FIG. 14(B) has the same beam width as that in FIG. 14(C), which is not shown.

Cross-polarization characteristics of the radiation device 1404 in FIG. 14(B) may be better than that of the radiation device 1404 in FIG. 14(C).

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

1. A radiation device in a broadband antenna comprising:
a first feeding point; and
a first dipole member electrically connected to the first feeding point,
wherein at least one first branch member is formed to one side of the first dipole member, and one or more second branch member is formed to another side of the first dipole member.

2. The radiation device of claim 1, wherein the first branch members and the second branch members are symmetrically disposed.

3. The radiation device of claim 1, wherein length of the first branch member reduces according as distance of the first branch member and the first feeding point increases.

4. The radiation device of claim 1, wherein at least one of the first branch members is not parallel to the other first branch members.

5. The radiation device of claim 1, wherein at least one of the first branch members has different width from the other first branch members.

6. The radiation device of claim 1, further comprising:
a second feeding point; and
a second dipole member electrically connected to the second feeding point,
wherein a third branch member facing to the first branch member is formed to one side of the second dipole member, and electromagnetic coupling generates between the third branch member and the first branch member.

7. The radiation device of claim 6, wherein the first branch member is disposed in parallel to the third branch member.

8. The radiation device of claim 6, wherein space between the first branch member and the third branch member reduces according as distance between the first branch member or the third branch member and corresponding feeding point increases.

9. The radiation device of claim 1, wherein space between the first branch member and the third branch member increases according as distance between the first branch member or the third branch member and corresponding feeding point augments.

10. The radiation device of claim 1, wherein at least one of the first branch members and the second branch members is separable from the first dipole member.

11. A radiation device in a broadband antenna comprising:
a first feeding point and a second feeding point;
a first dipole member electrically connected to the first feeding point; and
a second dipole member electrically connected to the second feeding point,
wherein at least one first branch member is formed to a side of the first dipole member, one or more second branch member facing to the first branch member is formed to a side of the second dipole member, and electromagnetic coupling generates between the first branch member and the second branch member.

12. A broadband antenna comprising:
a reflection plate; and
a radiation device disposed on the reflection plate,
wherein the radiation device includes:
a first feeding point; and
a first dipole member electrically connected to the first feeding point,
and wherein at least one first branch member is formed to one side of the first dipole member, and one or more second branch member is formed to another side of the first dipole member.

13. The antenna of claim 12, wherein the first branch members are symmetrically disposed to the second branch members, and length of the first branch member reduces according as distance between the first branch member and the first feeding point increases.

14. The antenna of claim 12, further comprising:
a second feeding point; and
a second dipole member electrically connected to the second feeding point,
wherein at least one third branch member facing to the first branch member is formed to a side of the second dipole member, and electromagnetic coupling generates between the third branch member and the first branch member.
